(19) United States
(12) Patent Application Publication
(10) Pub. No.: US 2011/0007014 A1
(43) Pub. Date: Jan. 13, 2011

(54) METHOD AND APPARATUS FOR SCROLLING IN PORTABLE TERMINAL

(75) Inventor: Yo-Han CHANG, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/830,801

(22) Filed: Jul. 6, 2010

(30) Foreign Application Priority Data
Jul. 10, 2009 (KR) 10-2009-0062898

(51) Int. Cl. G06F 3/041; G06F 3/048

(52) U.S. Cl. 345/173; 715/787

(57) ABSTRACT

A method and apparatus for scrolling in a portable terminal are provided. The method includes displaying data, sensing if scrolling is generated in a screen, and moving the data displayed on the screen based on a scrolling extent preset by region and/or displaying detailed information of the data displayed on the screen, in accordance with a region in which the scrolling is generated.

### PRIORITY

This application claims the benefit under 35 U.S.C. §119(a) of a Korean patent application filed in the Korean Intellectual Property Office on Jul. 10, 2009, and assigned Serial No. 10-2009-0062898, the entire disclosure of which is hereby incorporated by reference.

### BACKGROUND OF THE INVENTION

1. Field of the Invention

The present invention relates to a method and apparatus for scrolling in a portable terminal. More particularly, the present invention relates to a scrolling method and apparatus for enabling a user to intuitively scroll to a desired item in a portable terminal.

2. Description of the Related Art

In recent years, as portable terminals provide an increasing variety of functions for user convenience, information to display on a screen of the portable terminal gradually increases. However, because the screen of the portable terminal is small in size, information displayable on one screen is limited in amount. Thus, users have to input a move or scroll key several times to view information not displayed on the screen.

FIG. 1 is a diagram illustrating a screen making use of a scrolling technique in a portable terminal according to the conventional art.

Referring to FIG. 1, conventional portable terminals use a scheme of moving data displayed on a screen through a thumb 101 of a scrollbar. The move scheme through the scrollbar represents a scheme of moving data displayed on the screen up/down or left/right so as to display non-displayed data on the screen. For example, a scroll-up operation moves the contents of the whole screen up to make data displayed in an upper portion of the screen scroll off the screen and make new data be seen in a lower portion of the screen. This scrolling scheme enables a user to estimate the whole data amount and know an approximate position on a sequence in which current data among the whole data is sorted.

In general, when a user scrolls to a position of specific data in a list using the scroll in a portable terminal, it takes a considerable time to read the data of the position. The conventional portable terminal does not update the list during a scroll motion and, after the scroll stops, updates the list by the data of the position and provides the updated list to the user. However, this scheme has a problem in which the user may not be aware of the extent the user needs to scroll to view desired data or what data is present in a current scrolled position.

Recent portable terminals attempt to solve these issues through a scrollbar having an index. In this scheme a numeric or alphabetic index between a position of the scroll and corresponding data is previously established. If the user moves the scroll, an index is displayed corresponding to a moved position on a screen, thereby helping the user estimate data corresponding to a current position of the scroll through the index.

However, the above scheme using the index has a limitation regarding the user's ability to accurately estimate corresponding data. For example, when a numeral index is provided, there is a problem that, with only the numeric index, a user cannot be accurately aware of a position in which the desired data exists and, in the end, the user scrolls several times. Also, there is a problem in that the above scheme is not available when the user newly sorts a list.

### SUMMARY OF THE INVENTION

An aspect of the present invention is to address at least the above-mentioned problems and/or disadvantages and to provide at least the advantages described below. Accordingly, an aspect of the present invention is to provide a scrolling method and apparatus in a portable terminal.

Another aspect of the present invention is to provide a method and apparatus for, upon scrolling, providing detailed information of a corresponding item to enable a user to easily scroll to a desired item in a portable terminal.

Another aspect of the present invention is to provide a method and apparatus for, upon scrolling, controlling a scrolling extent by region of a screen to enable a user to easily scroll to a desired item in a portable terminal.

Another aspect of the present invention is to provide a method and apparatus for previously storing a predetermined amount of detailed information displayable on a screen and, upon scrolling, directly displaying the detailed information on the screen in a portable terminal.

Another aspect of the present invention is to provide a method and apparatus for, in accordance with a list sorting reference, changing detailed information displayed upon scrolling in a portable terminal.

The above aspects are achieved by providing a scrolling method and apparatus in a portable terminal.

In accordance with an aspect of the present invention, a scrolling method in a portable terminal is provided. The method includes displaying data, sensing if scrolling is generated in a screen, and moving the data displayed on the screen based on a scrolling extent present by region or displaying detailed information of the data displayed on the screen in accordance with a region in which the scrolling is generated.

In accordance with another aspect of the present invention, a scrolling apparatus in a portable terminal is provided. The apparatus includes a display unit, an input unit, and a controller. The display unit displays data. The input unit recognizes a coordinate of a touched region of the display unit. The controller senses scrolling generation through the coordinate, and moves the displayed data based on a scrolling extent preset by region or displays detailed information of the displayed data in accordance with a region in which the scrolling is generated.

In accordance with another aspect of the present invention, a portable terminal is provided. The portable terminal includes a display unit for displaying a portion of a list of items, an input unit for receiving input from a user, and a controller for sensing a scrolling operation input by the user via the input unit and for controlling the display unit to display a different portion of the list based on a scrolling extent present by region or for controlling the display unit to display detailed information of the displayed items according to a region of the display unit in which the scrolling operation is sensed.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a diagram illustrating a screen making use of a scrolling technique in a portable terminal according to the conventional art;

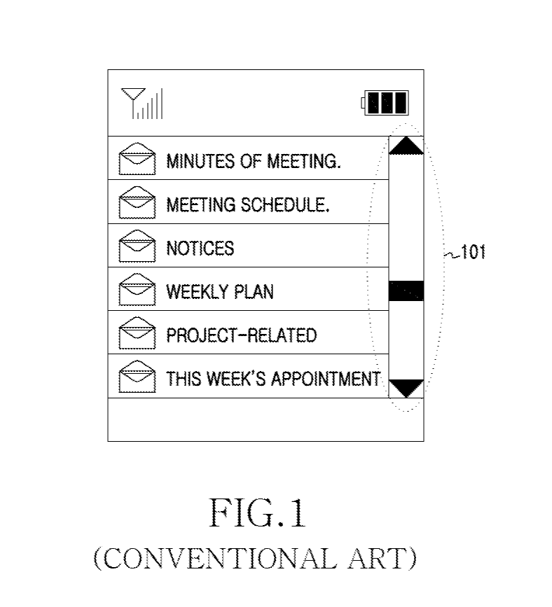

FIG. 2 is a block diagram illustrating a portable terminal according to an exemplary embodiment of the present invention;

FIG. 3 is a flow diagram illustrating a scrolling procedure in a portable terminal according to an exemplary embodiment of the present invention;

FIG. 4 is a diagram illustrating a screen showing a scrolling extent by region in a portable terminal according to an exemplary embodiment of the present invention;

FIGS. 5A to 5C are diagrams illustrating screens executing scrolling by region in a portable terminal according to an exemplary embodiment of the present invention;

FIG. 6 is a flow diagram illustrating a procedure for showing scrolling information in a portable terminal according to an exemplary embodiment of the present invention; and

FIGS. 7A and 7B are diagrams illustrating screens showing scrolling information in a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following description is made for a scrolling method and apparatus for displaying detail information of each item according to scrolling, and controlling a scrolling extent by region of a screen to enable a user to easily scroll to a desired item in a portable terminal. In the following description, scrolling or scroll operation represents an operation of directly moving up/down or left/right a thumb of a scrollbar displayed on a screen, or represents an operation of touching a predetermined region of the screen in an up/down or left/right direction.

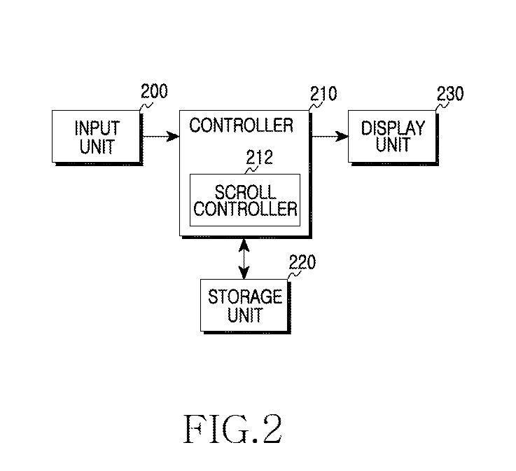

FIG. 2 is a block diagram illustrating a portable terminal according to an exemplary embodiment of the present invention.

Referring to FIG. 2, the portable terminal includes an input unit 200, a controller 210, a storage unit 220, and a display unit 230. The controller 210 includes a scroll controller 212. The portable terminal may also include additional units. Similarly, the functionality of two or more of the above units may be integrated into a single device.

The input unit 200 may include, among others, a numeral key, a character key, and a plurality of function keys. The input unit 200 provides the controller 210 with key input data corresponding to a key pressed by a user. The input unit 200 may further include a touch screen panel, recognize a coordinate of a touched region of the display unit 230, and provide the recognized coordinate to the controller 210.

The controller 210 controls and processes a general operation of the portable terminal. The controller 210 includes the scroll controller 212 to control and process a screen display according to user's scrolling.

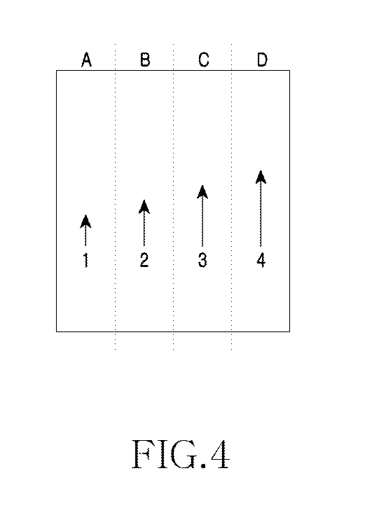

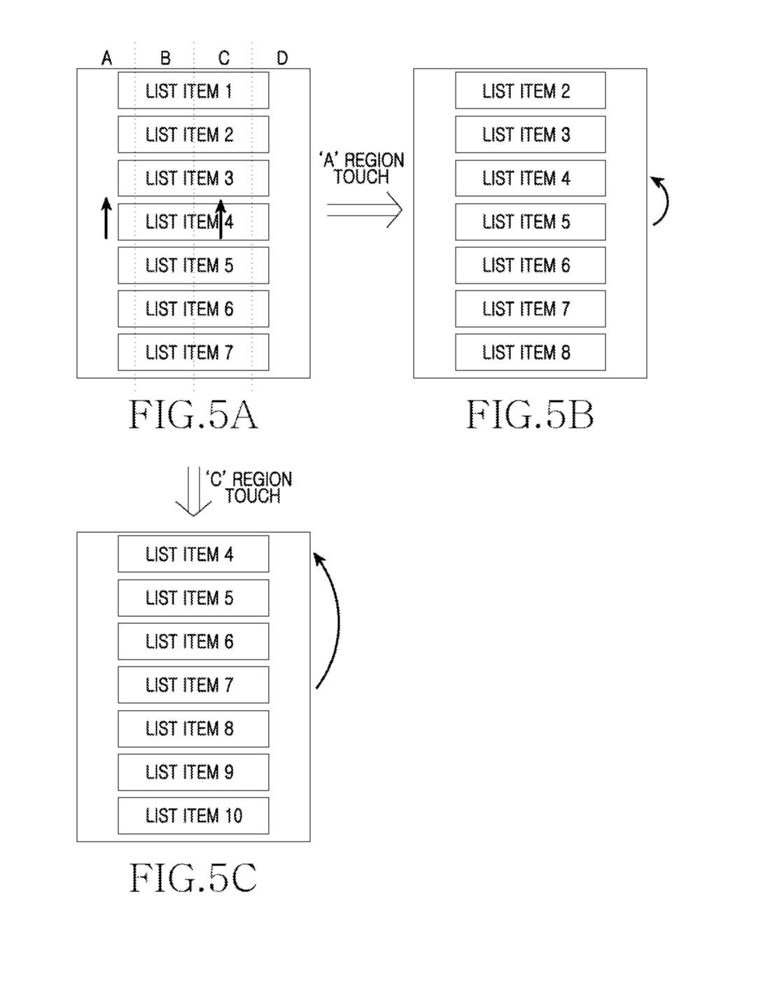

The scroll controller 212 divides a screen into a predetermined number of regions and sets a scrolling extent by each region. If the user touches a specific region of the display unit 230, as determined through a coordinate provided from the input unit 200, and performs a scrolling operation, the scroll controller 212 updates data displayed on a current screen according to a scrolling extent of a corresponding region. Examples of the operation of the scroll controller 212 are described below with respect to FIGS. 4 and 5A-5C.

FIGS. 4 and 5A to 5C are diagrams illustrating screens executing scrolling by region in a portable terminal according to an exemplary embodiment of the present invention.

Referring to FIGS. 4 and 5A-5C, the scroll controller 212 divides a screen into ‘A’, ‘B’, ‘C’, and ‘D’ regions and then sets a scrolling extent of each region to ‘1’, ‘2’, ‘3’, and ‘4’. As illustrated in FIGS. 5A-5C, if a scroll-up operation is generated in the ‘A’ region, the scroll controller 212 moves up data displayed on the screen by ‘1 ’ to update the screen. If a scroll-up operation is generated in the ‘C’ region, the scroll controller 212 moves up the data displayed on the screen by ‘3 ’ to update the screen.

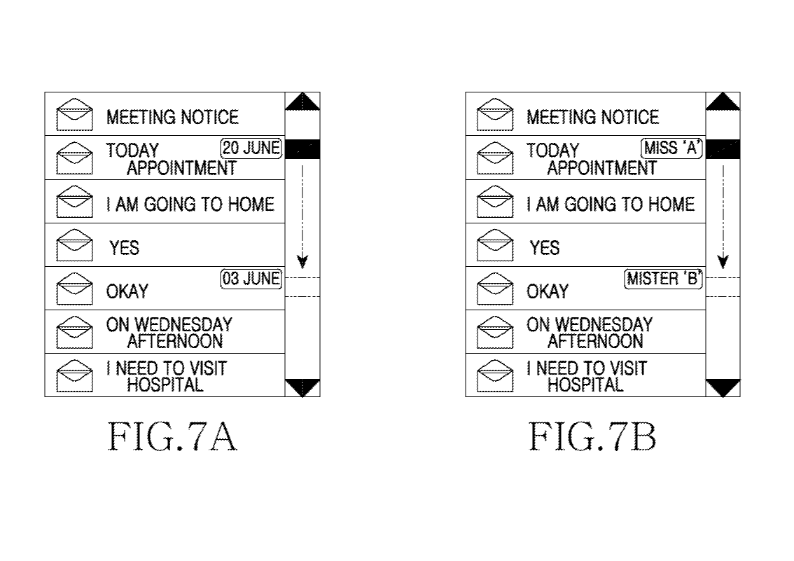

When displaying a data list on a screen, the scroll controller 212 controls and processes a function for displaying detail information of each item constituting the list according to user's scrolling. For example, when displaying a list of character messages, the scroll controller 212 displays detailed information on a character message corresponding to the user's scrolling. The detailed information may be, for example, a sending date, a reception date, a sender name, and a receiver name. The scroll controller 212 may either display sending date or reception date information as illustrated in FIG. 7A, or may display sender name and receiver name information as illustrated in FIG. 7B.

The scroll controller 212 also performs a function for previously storing detailed information on partial data among the whole data constituting the list and, when the scrolling takes place, directly displaying the detailed information on the screen. For example, when a list of character messages is displayed, and the list of character messages includes one hundred character messages, of which five character messages are displayed, the scroll controller 212 can previously store detailed information on the displayed five character messages and the next five character messages (i.e., a first character message to a tenth character message when the first through fifth messages are displayed). Previously storing the detailed information of the partial data prevents the occurrence of a time delay in reading detailed information on corresponding data. The scroll controller 212 controls changes in the displayed detailed information according to scrolling in accordance with a list sorting scheme. For example, if a list of character messages is sorted by date, the scroll controller 212 controls the display of a reception date by detailed information according to scrolling as illustrated in FIG. 7A. If the list of character messages is sorted by sender name, the scroll controller 212 controls the display of a sender name by the detailed information as illustrated in FIG. 7B.

The storage unit 220 stores various kinds of programs and data for general operation of the portable terminal. The display unit 230 displays various kinds of state information and data generated during operation of the portable terminal. If the user's scrolling occurs, the display unit 230 displays detailed information of corresponding data under the control of the scroll controller 212.

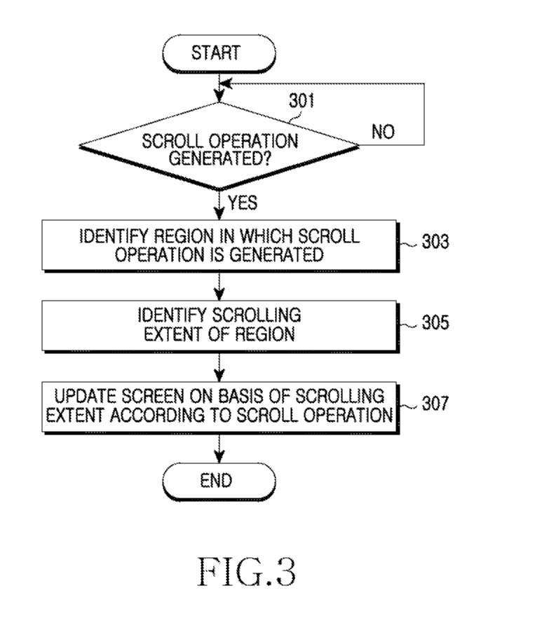

FIG. 3 illustrates a scrolling procedure in a portable terminal according to an exemplary embodiment of the present invention.

Referring to FIG. 3, in step 301, the portable terminal determines if a scroll operation is generated. For example, the portable terminal determines if a user touches a predetermined region of a screen in an up/down or left/right direction.

If the scroll operation is generated, the portable terminal identifies a region in which the scroll operation is generated in step 303. The portable terminal then proceeds to step 305 and identifies a scrolling extent according to the scroll operation of the region. In step 307, the portable terminal updates data displayed on a screen based on the scrolling extent according to the scroll operation of the region. For example, if the screen is divided into four regions ‘A’, ‘B’, ‘C’, and ‘D’ and a scrolling extent of each region is set to ‘1’, ‘2’, ‘3’, and ‘4’, as illustrated in FIG. 4, if a scroll-up operation is generated in the ‘A’ region, the portable terminal moves up data displayed on a screen by ‘1’ to update the screen and, if the scroll-up operation is generated in the ‘C’ region, the portable terminal moves up the data displayed on the screen by ‘3’ to update the screen.

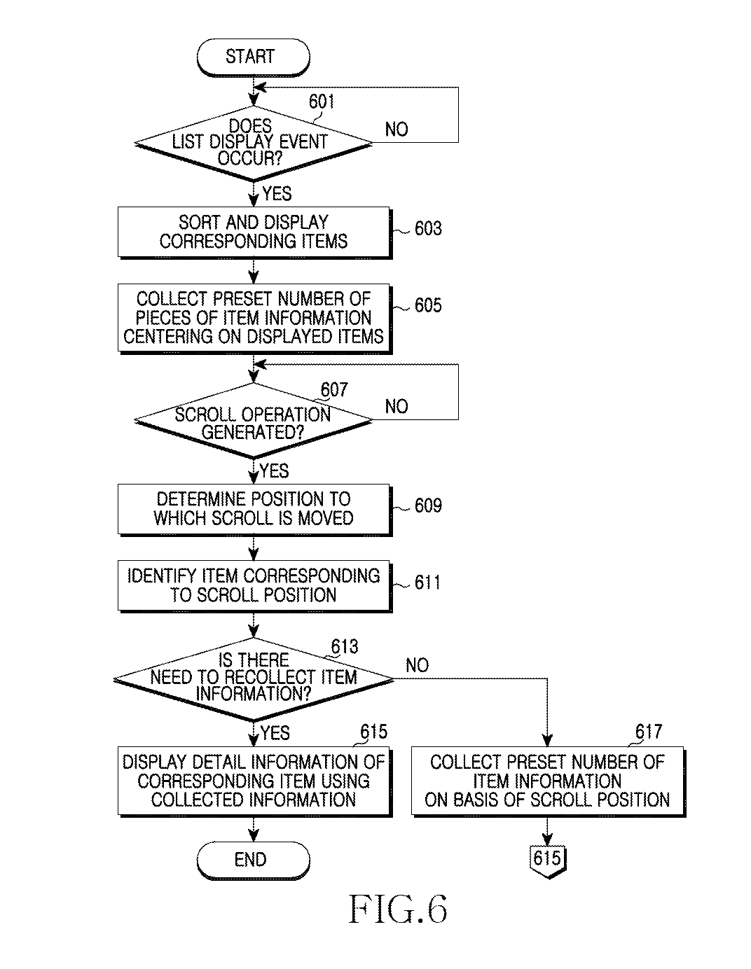

FIG. 6 illustrates a procedure for showing scrolling information in a portable terminal according to an exemplary embodiment of the present invention.

Referring to FIG. 6, if a list display event occurs in step 601, the portable terminal sorts and displays items constituting a list in step 603. For example, if an event for displaying a list of received character messages takes place, the portable terminal sorts and displays the received character messages in accordance with a preset sorting scheme.

In step 605, the portable terminal collects detailed information on a preset number of items centering on the displayed items. For example, if the list of received character messages includes one hundred character messages, of which the first to seventh character messages are displayed according to a sorting sequence, the portable terminal previously collects detailed information on the displayed seven character messages and the next sorted five character messages.

In step 607, the portable terminal determines if a scroll operation is generated. For example, the portable terminal determines if a thumb of a scrollbar displayed on a screen is moved up/down or left/right by a user. If the scroll operation is generated, the portable terminal proceeds to step 609 and determines a position to which the scroll is moved. In step 611, the portable terminal identifies an item corresponding to the position to which the scroll is moved.

In step 613, the portable terminal determines if the item corresponding to the position to which the thumb is moved corresponds to the previously collected item to determine if there is a need to recollect detailed information on items. If the item corresponding to the position to which the scroll is moved does not correspond to the previously collected item, the portable terminal proceeds to step 617 and recollects a preset amount of item information based on the item corresponding to the position to which the scroll is moved. After that, the portable terminal proceeds to step 615. If it is determined in step 613 that the item corresponding to the position to which the scroll is moved corresponds to the previously collected item, the portable terminal proceeds to step 615 and displays detailed information of the item corresponding to the position to which the scroll is moved, using the previously collected detail information.

FIGS. 7A and 7B are diagrams illustrating screens showing scrolling information in a portable terminal according to an exemplary embodiment of the present invention.

Referring to FIGS. 7A and 7B, the portable terminal may change the displayed detailed information in accordance with the list sorting scheme. For example, if the list of received character messages is sorted by date, the portable terminal displays a reception date by detailed information according to scrolling as illustrated in FIG. 7A. If the list of received character messages is sorted by sender name, the portable terminal may display a sender name by the detailed information as illustrated in FIG. 7B.

The present invention has an effect of, by displaying detailed information of each item according to scrolling, controlling a scrolling extent by region of a screen to enable a user to easily scroll to a position in which desired data exists, and changing the displayed detail information in accordance with a list sorting scheme, making it possible to select the list sorting scheme in accordance with user convenience to access the desired data in a portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A scrolling method in a portable terminal, the method comprising:
displaying data;
sensing if scrolling is generated in a screen; and
moving the data displayed on the screen based on a scrolling extent preset by region and/or displaying detailed information of the data displayed on the screen in accordance with a region in which the scrolling is generated.

2. The method of claim 1, wherein the sensing if the scrolling is generated in the screen comprises sensing if a thumb of a scrollbar is moved or an operation of touching a scroll non-display region up/down or left/right is performed.

3. The method of claim 2, wherein the moving of the data or displaying of the detailed information in accordance with the region in which the scrolling is generated comprises:
when the thumb is moved, displaying the detailed information of the data displayed in the screen; and
when the operation of touching the scroll non-display region up/down or left/right is generated, moving the data displayed on the screen in accordance with a scrolling extent of a region in which the touching operation is generated.

4. The method of claim 1, wherein the screen is divided into a plurality of regions and is set to have a different scrolling extent by region.

5. The method of claim 1, wherein the displaying of the detailed information comprises:
determining a position to which a thumb of a scrollbar is moved according to the scrolling generation; and
displaying detailed information of data corresponding to the position to which the thumb is moved.

6. The method of claim 1, wherein the detailed information of the displayed data is changed in accordance with a sorting scheme of a list of the data displayed on the screen.

7. The method of claim 1, further comprising previously collecting detailed information on a predetermined amount of data based on data displayed on the screen among the whole data constituting a data list displayed on the screen.

8. The method of claim 1, wherein, when a list of messages is displayed on the screen, the detailed information comprises at least one of a sending date, a reception date, a sender name, and a receiver name.

9. A scrolling apparatus in a portable terminal, the apparatus comprising:
a display unit for displaying data;
an input unit for recognizing a coordinate of a touched region of the display unit; and
a controller for sensing scrolling generation through the coordinate, and moving the displayed data based on a scrolling extent preset by region and/or displaying detailed information of the displayed data in accordance with a region in which the scrolling is generated.

10. The apparatus of claim 9, wherein the controller senses if a thumb of a scrollbar is moved through the coordinate or a predetermined scroll non-display region is touched up/down or left/right.

11. The apparatus of claim 10, wherein, when the thumb is moved, the controller displays the detailed information of the data displayed on the display unit and, when the scroll non-display region is touched up/down or left/right, the controller moves the data displayed on the display unit in accordance with a scrolling extent of a region in which the touching operation is generated.

12. The apparatus of claim 9, wherein the controller divides a screen of the display unit into a plurality of regions and sets each region to have a different scrolling extent.

13. The apparatus of claim 9, wherein the controller determines a position to which a thumb of a scrollbar is moved according to the scrolling generation, and controls the display unit to display detailed information of data corresponding to the position to which the scroll is moved.

14. The apparatus of claim 9, wherein the controller changes the detailed information of the displayed data in accordance with a sorting scheme of a list of the data displayed on the display unit.

15. The apparatus of claim 9, wherein the controller previously collects detailed information on a predetermined amount of data based on data displayed on a screen among the whole data constituting a data list displayed on the display unit.

16. The apparatus of claim 9, wherein, when a list of messages is displayed on the display unit, the detailed information comprises at least one of a sending date, a reception date, a sender name, and a receiver name.

17. A portable terminal comprising:
a display unit for displaying a portion of a list of items;
an input unit for receiving input from a user; and
a controller for sensing a scrolling operation input by the user via the input unit and for controlling the display unit to display a different portion of the list based on a scrolling extent present by region or for controlling the display unit to display detailed information of the displayed items according to a region of the display unit in which the scrolling operation is sensed.

18. The portable terminal of claim 17, wherein the controller further comprises a scroll controller for controlling the display unit to display the portion of the list or the detailed information.

19. The portable terminal of claim 18, wherein the scroll controller divides the display unit into a plurality of regions and controls the display unit to scroll the list of items by a different amount based on a region in which the display unit was touched by the user.

20. The portable terminal of claim 17, wherein the controller collects information on an additional portion of the list of items determined based on the portion of the list of items displayed on the display unit, and when the scrolling operation is sensed and the controller determines that the different portion of the list corresponds to the collected information, controls the display of the different portion of the list based on the collected information.
